(19) United States
(12) Patent Application Publication
(10) Pub. No.: US 2007/0063580 A1
(43) Pub. Date: Mar. 22, 2007

(54) Concentric series power springs located in the middle of the spring brake actuator

(75) Inventors: Kenneth E. Scheckelhoff, Elyria, OH (US); Ronald S. Plantan, Westlake, OH (US); Brett S. Darner, Wellington, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Commercial Vehicle Systems, LLC, Elyria, OH (US)

(21) Appl. No.: 11/229,640

(22) Filed: Sep. 20, 2005

(51) Int. Cl. B60T 13/74

(52) U.S. Cl. 303/115.1; 303/3; 92/63; 267/64.11

(57) ABSTRACT

A power spring arrangement of a spring-type brake actuator for a vehicle brake, in which the actuator's power spring is located between the service brake actuator and parking brake release actuator, and the power spring comprises a plurality of concentric springs. The power spring is captured between the actuator's intermediate flange and a spring retainer. The use of two or more concentric springs allows higher parking brake actuator force to be generated than with a standard single power spring, without the need to enlarge the actuator housing or to use more costly spring materials or spring configurations.

### BACKGROUND AND SUMMARY OF THE INVENTION

The present invention relates to spring-type brake actuators, and in particular to arrangements of power springs within such actuators to provide increased parking brake actuation force.

So-called “spring brake” actuators are commonly used to provide service, parking and emergency brake operation on vehicles such as commercial trucks, tractors and trailers equipped with lever-operated drum or disc brakes. Spring-type brake actuators are typically pneumatically operated, and are supplied with operating air from a compressed air source on the vehicle. These actuators also typically are arranged in a “fail-safe” manner, i.e., where the actuator defaults to a brake application state upon loss of operating air pressure.

An example prior art spring brake actuator is shown in cross-section view in FIG. 1. Actuator housing 1 includes a rear cylinder 2 in which a rear piston 3 is displaceably arranged. The inner wall of the rear cylinder and a chamber-side of the rear piston define a rear ventilation chamber 4. The other side of the rear piston bears on a brake actuator spring 5. This spring is also known in the art as a “power spring” or a “parking brake spring,” and these terms may be used interchangeably. For consistency herein, the terms “brake actuator spring” or “actuator spring” will be used. The rear ventilation chamber is isolated from the spring side of piston 3 by an annular seal 6. An intermediate flange 8 (also known as a “wall”) separates rear cylinder 2 from a front cylinder 9. The intermediate flange 8 traversed by a seal 10 through which passes a sliding rod 11, formed as an extension of rear piston 3. The sliding rod 11 can be displaced in the intermediate flange 8 by the rear piston. A front ventilation chamber 7 within front cylinder 9 is delimited by the cylinder inner wall and a front piston 13 and annular diaphragm 14. The rear piston 3 and the front piston 13 are in non-coupled contact with one another by means of the sliding rod 11, such that the front piston 13 can be displaced in a brake application direction by the rear piston 3. An actuating rod 15 for actuating a brake lever of a vehicle brake is provided on the front side of the front piston 13.

When no pneumatic pressure is present in the FIG. 1 actuator unit, the brake actuation spring 5 applies a high spring force to rear piston 3, which in turn applies this force via sliding rod 11 to front piston 13 to cause the actuator rod 15 to apply the vehicle brake. In this state, the vehicle brake functions as a parking brake, preventing vehicle movement. When release of the parking brake is desired, the rear ventilation chamber 4 is filled with compressed air via port 19. As the force generated by the increasing air pressure on the front side of rear piston 3 exceeds the force generated by brake application spring 5, the rear piston 3 and sliding rod 11 move toward the rear of the rear cylinder 2, compressing spring 5. At the same time, as sliding rod 11 moves towards the rear, the force previously applied to front piston 13 is relieved, and the return spring 18 biases the front piston 13 toward the rear of front cylinder 9, thereby withdrawing actuating rod 15 away from and releasing the vehicle brake. The vehicle therefore moves from a state in which it is braked by the brake actuator spring 5, to a non-braked state in which the vehicle may be moved.

The vehicle brake is applied as a service brake during normal operation by admitting compressed air into the front ventilation chamber 7 (via a port not shown in FIG. 1). Because air pressure in rear ventilation chamber 4 continues to hold sliding rod 11 at the rear of the rear cylinder 2, the front piston 13 and actuating rod 15 are free to move forward and backward within the front cylinder as necessary to respond to the operator's brake actuation demands. In the event of failure of the compressed-air supply during operation of the vehicle, the pressure in the rear ventilation chamber 4 decreases. As a result, the brake actuation spring 5 automatically pushes the rear piston 3 back to the starting (parking) position. Sliding rod 11 thus presses on the front piston 13, which in turn pushes the actuating rod 15 in the brake application direction to actuate the vehicle brake. Thus, fail-safe emergency operation of the vehicle brake is assured.

As discussed in pending U.S. patent application Ser. No. 11/012,313, filed Dec. 16, 2004, prior art spring-type brake actuators have a number of problems. application Ser. No. 11/012,313 discloses an improved actuator which is safer, lighter, simpler, more reliable, less costly and/or safer to assemble and service than prior art actuators. As shown in FIG. 2, this new approach to spring-brake actuators is arranged with its brake actuator spring 140 (also known as a “power spring”) relocated to the front portion of the actuator housing 110, occupying a position between the front service brake actuator 180 and the rear parking brake actuator 170. When the spring brake actuator is inactive (i.e., no pressure exists in either the front or rear chambers), the brake actuator spring 140 applies the vehicle brake by pressing on the service brake actuator 180 via an intermediate spring retainer in the form of spring plate 160, and the service brake actuator 180 in turn presses the brake actuator rod 190 forward in a brake application direction.

The parking brake release actuator, instead of pressing directly on the service brake actuator (as in the prior art), is affixed via its attached shaft 200 to the intermediate spring plate 160. Thus, when air pressure is applied to the rear chamber, rather than compressing the brake actuator spring into the rear end of the actuator housing, as in the prior art, the parking brake release actuator draws the intermediate spring plate toward the intermediate body portion 110 of the actuator, compressing the brake actuator spring against the front side (or “floor”) of the intermediate flange to remove the spring's force from the actuator rod. This arrangement preserves the “fail-safe” nature of the spring-type brake actuator (i.e., loss of pressure in the rear chamber still results in the brake actuator spring re-applying the brake), while also positively capturing the spring between the spring plate and the intermediate flange.

One of the features of the new spring brake actuator is the location of the brake actuator spring 140 immediately adjacent to the front chamber 300, where it can generate substantial force to actuate the brake in a “parking brake” mode when pressure is released from parking brake chamber 230. The amount of force the power spring generates is determined by a number of factors, including the spring material, the diameter of the spring wire, the diameter of the spring, the spring length, the spring's coil pitch, and the distance the spring is displaced from its unloaded length.

As a general rule, the greater the desired parking brake actuation force, the larger the spring must be (e.g., larger coil wire, spring diameter, and/or length). One approach to obtaining greater parking brake actuation force would be to enlarge the diameter power spring. However, enlarging the spring would require that the actuator housing also be enlarged to accommodate the larger spring. Enlargement of the brake actuator housing may be undesirable for a number of reasons, including the need to minimize actuator size in order to fit within limited space envelopes in commercial vehicle brake applications, and the need to incur substantial additional costs for designing, manufacturing and supporting multiple sizes of spring brake actuator housings. These latter concerns become particularly acute when larger housings must be provided, but because demand for the larger housings would likely be limited, the larger spring brake actuators would be unprofitable at market-acceptable prices.

Alternatively, if the diameter and/or length of the spring cannot be increased, the spring rate (the amount of force required to displace the spring over a given distance) generally must be increased by increasing the diameter of the coil wire used in the spring and/or by using a stiffer (i.e., lower elasticity) material for the coil. However, achieving greater parking brake actuation force by simply increasing spring rate is not a preferred approach, at least in part due to concerns with increased component cost and potentially lower fatigue life of larger, stiffer spring materials.

In view of the foregoing, it is an objective of the present invention to provide an improved power spring arrangement in which different parking brake actuation force levels may be provided within a single actuator housing design.

It is a further objective of the present invention to provide a power spring arrangement which eliminates the need to design, tool, manufacture and support different size brake actuator housings in order to meet higher parking brake actuator force demands.

In addressing these and other objectives, the present invention includes a plurality of concentric power springs located in the power spring cavity of the actuator housing. The springs are preferably provided with a separator between adjacent springs, and the separator is preferably provided with flanges at its ends to receive opposite ends of the adjacent concentric spring coils. In addition to precluding interference between the concentric springs' coils, such a separator causes adjacent springs to act in “series,” i.e., generates a reaction force which passes in series from a rear of the power spring cavity through a first spring, the separator, and a second spring to the spring retainer plate.

This series application effectively extends the distance over which the combined concentric springs can apply a high parking brake actuation force. The separator allows the springs to be nested one within the other when the springs are fully compressed into the actuator's power spring cavity, while simultaneously allowing one spring to effectively serve as the seat for its adjacent spring. Thus, when the power springs are allowed to advance in a brake application direction, the displacement of the separator towards the brake by the one spring advances the adjacent concentric spring's seat (the separator flange) toward the brake. As a result, the adjacent spring is also displaced toward the brake, allowing it to exert its spring force over a greater distance than if it were seated against the rear of the power spring cavity. Accordingly, at any given distance from the power spring cavity, the brake application force applied to the spring retainer by the series concentric springs will be higher than if both springs were resting against the rear of the power cavity.

The concentric spring arrangement allows a single brake actuator housing to accommodate both a “standard” single power spring which provides sufficient parking brake actuation force for most applications, and to accommodate multiple power springs to provide a higher parking brake actuation force in more demanding brake applications. The use of multiple concentric power springs also allows the individual springs' spring rates to remain in a desirably low range, while providing a combined, overall spring rate that generates the desired parking brake actuation force within the spring length limits of the single brake actuator housing.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross-section view of an example prior art spring-type pneumatic brake actuator.

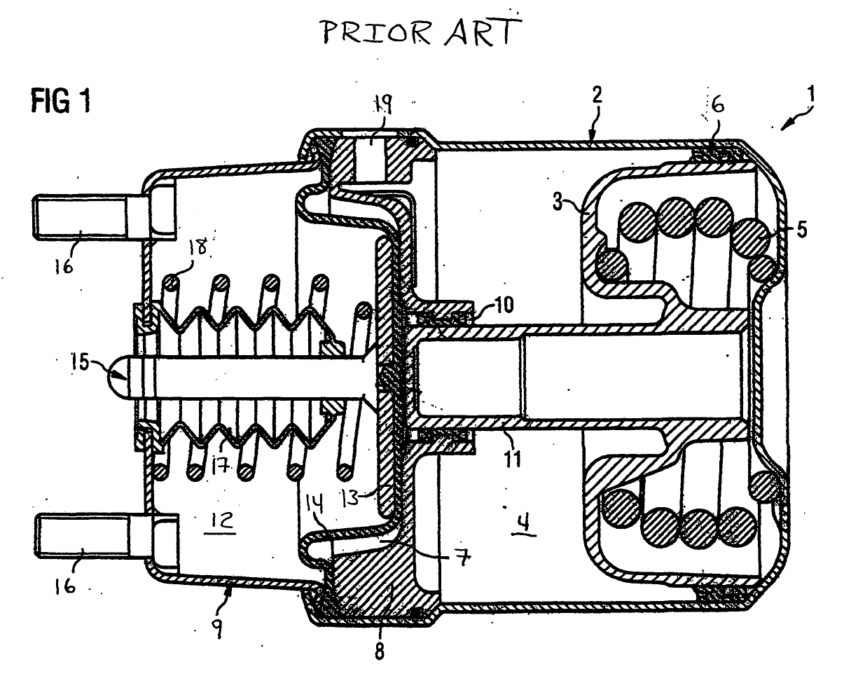

FIG. 2 is a cross-section view of an example embodiment of a mid-spring, spring-type brake actuator.

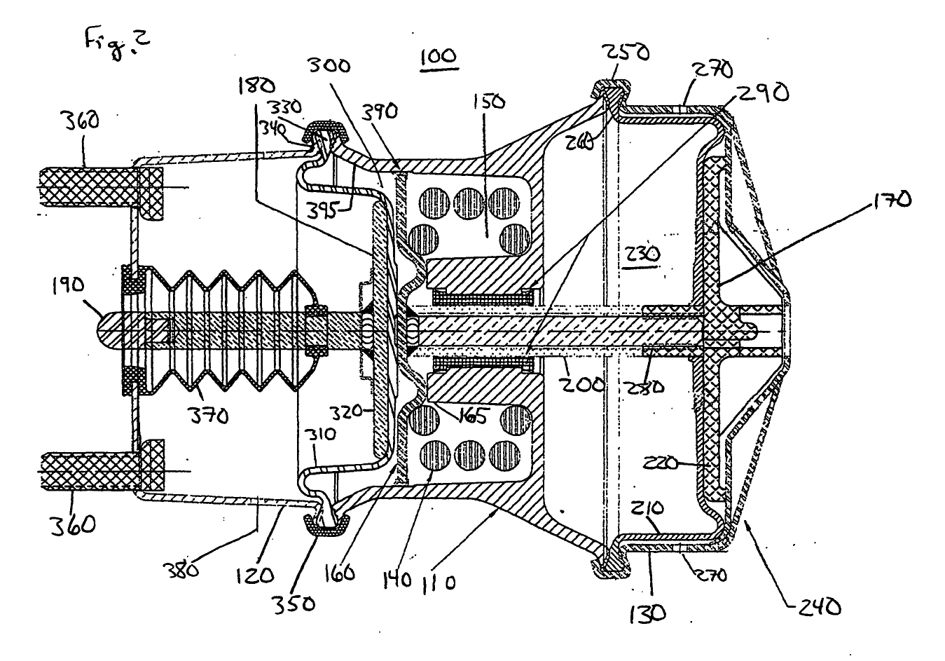

FIG. 3 is a cross-section view of an example embodiment of a mid-spring, spring-type brake actuator with multiple concentric power springs in accordance with an embodiment of the present invention.

FIG. 4 is a cross-section view of the multiple concentric power springs and separator shown in FIG. 3, with other spring-type brake actuator components omitted for clarity.

### DETAILED DESCRIPTION OF THE DRAWINGS

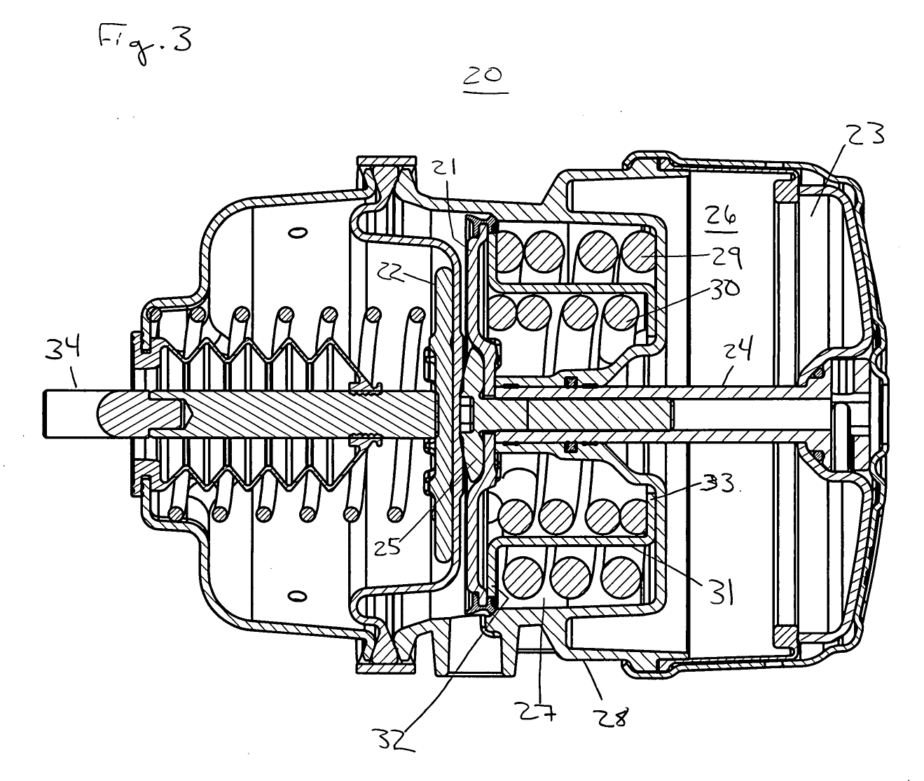

FIG. 3 is a cross-section view of a spring-type brake actuator 20 in accordance with an embodiment of an apparatus illustrating aspects of the present invention. The spring brake actuator 20 includes a spring plate 21 arranged between a service brake actuator 22 and a parking brake actuator 23. The spring plate 21 is affixed to the parking brake actuator 23 by an intermediate tube 24 and retaining screw 25, such that when pressure is applied in parking brake chamber 26, the spring plate is drawn towards the power spring cavity 27 of actuator housing intermediate portion 28.

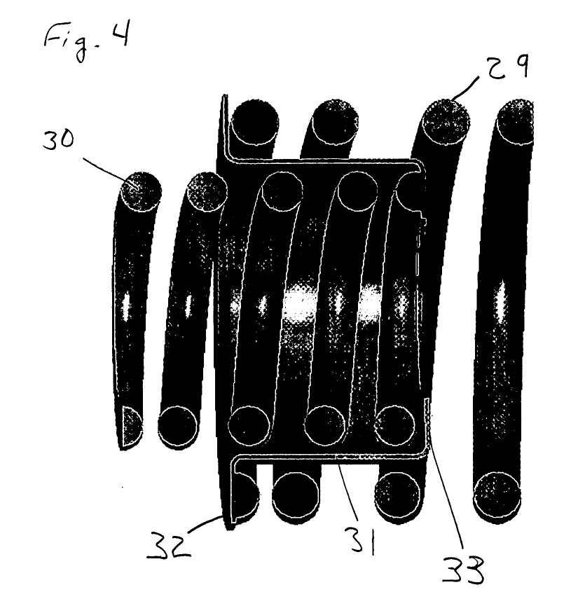

As illustrated in FIG. 3, when drawn toward the power spring cavity 27, the spring plate 21 compresses a plurality of concentric power springs, in this embodiment, outer power spring 29 and inner power spring 30, into the power spring cavity. A cup-shaped separator 31 is provided between the outer and inner spring coils. For clarity, these spring and separator arrangements, in an uncompressed state, are also illustrated in cross-section in FIG. 4, with the other spring-type brake actuator components omitted. A radially-outward flange 32 of the separator receives a brake-end face of outer power spring 29, while the opposite end of the spring 29 rests against the rear surface of the power spring cavity. The parking brake actuator end face of inner spring 30 rests against the opposite separator flange, radially inward-facing flange 33, and at the springs brake-end presses directly against the parking brake actuator-side face of the spring plate 21.

As shown in FIG. 3, when the parking brake release actuator 23 is fully withdrawn, the concentric power springs and their separator are contained within the power spring cavity by spring plate 21. As the parking brake release actuator 23 begins to move in a brake-actuation direction, one or both of the outer and inner power springs begins to move in the brake actuation direction (the timing of the start of the expansion of the second spring depending on the springs' individual spring rates and the retaining force applied by the parking brake release actuator on the spring plate). The expanding outer spring 29 displaces separator outer flange 32 in the brake actuation direction, thereby also moving the inner spring 30's seat (separator inner flange 33) in the brake actuation direction. This in turn displaces the inner spring 30 in the brake actuation direction, delaying the expansion of the inner power spring 30, and thus resulting in the parking brake actuation force applied to spring plate 21 (and, through service brake actuator 22, to brake actuation rod 34) remaining at higher levels over a greater spring plate displacement range than in the inner spring 30's parking brake actuator end-face was resting against the rear of the power spring cavity.

It will be apparent to one of ordinary skill in the art that the relative strengths of the individual concentric springs to one another may be varied while retaining the functionality of the foregoing embodiment and remaining within the scope of the present invention. One of ordinary skill will also recognize that the spring parameters (e.g., coil diameter, wire diameter, wire material, free length), also may be altered as necessary to ensure that the combined force of the plurality of power springs is sufficient to generate the desired parking brake actuation force at the spring plate throughout the range of motion of the brake actuator rod 34.

The use of multiple concentric power springs, and in particular concentric springs in a series arrangement such as that shown in the FIG. 3 embodiment, offers several advantages. The use of a plurality of concentric power springs in a common mid-spring brake actuator housing eliminates the need to incur substantial costs to design, build and support additional sizes of spring brake actuators to meet different parking brake actuation force demands. Use of a plurality of concentric springs also provides a spring brake actuator manufacturer with the ability to easily and at low cost tailor a spring brake actuator to obtain a desired parking brake actuation force, on the same production line as single-power spring-equipped spring brake actuators and without significant additional production tooling, by merely selecting and installing an appropriate combination of concentric power springs and separator(s). This approach offers further cost savings, in that lower-spring rate springs are generally less costly than their higher-strength, high spring rate counterparts, and thus the spring brake actuators may be assembled from lower cost spring components than in an equivalent heavy-duty single spring actuator. These various cost advantages become particularly important where there is a desire to meet a demand for a heavy-duty parking brake actuator, but the projected market volume is low, as they allow a price-competitive heavy-duty spring brake actuator to be made available to satisfy customer needs.

The foregoing disclosure has been set forth merely to illustrate the invention and is not intended to be limiting. For example, while the springs illustrated herein are formed from coil-wound wire, one of ordinary skill would recognize that other spring configurations may be readily substituted. For example coils of flat wire or other non-coil spring configurations may be employed; alternatively, an array of spring elements may be considered, such as a plurality of small-diameter springs arranged at close centers in two concentric large-diameter circles may be provided in place of two large individual concentric coil springs Similarly, the spring separator need not be a one-piece cup-shaped separator, but for example, may comprise a plurality of metal strips spaced about the annulus between two concentric springs. Because other such modifications of the disclosed embodiments incorporating the spirit and substance of the invention may occur to persons skilled in the art, the invention should be construed to include everything within the scope of the appended claims and equivalents thereof.

What is claimed is:

1. A spring brake actuator, comprising:
a brake actuator spring;
a parking brake release actuator;
a service brake actuator;
a spring brake actuator housing containing the service brake actuator, the parking brake release actuator, and the brake actuator spring between the brake actuators; and
a spring retainer disposed between the brake actuator spring and the service brake actuator and coupled to the parking brake release actuator;
wherein the brake actuator spring comprises a plurality of concentric springs.

2. The spring brake actuator of claim 1, wherein the springs are concentric with an axis passing through centers of the spring retainer and the parking brake release actuator.

3. The spring brake actuator of claim 2, wherein the plurality of concentric springs consists of two concentric springs.

4. The spring brake actuator of claim 1, further comprising:
at least one spring separator disposed between adjacent concentric springs.

5. The spring brake actuator of claim 4, wherein first and second spring-seat end flanges are formed at opposite ends of at least one separator, the first flange receiving an end face of a first one of the concentric springs, and the second flange receiving an end face of a second one of the concentric springs, such that spring force is transferred in series from the first one of the springs through the separator to the second one of the springs.

6. A vehicle brake assembly, comprising:
a brake, wherein the brake includes one of a disc brake and a drum brake; and
a spring brake actuator coupled to the brake to apply a brake actuation force, the spring brake actuator having a housing containing
a parking brake release actuator;
a service brake actuator;
a brake actuator spring disposed between the brake actuators; and
a spring retainer disposed between the brake actuator spring and the service brake actuator and coupled to the parking brake release actuator;
wherein the brake actuator spring comprises a plurality of concentric springs.

7. The vehicle brake assembly of claim 6, wherein the springs are concentric with an axis passing through centers of the spring retainer and the parking brake release actuator.

8. The vehicle brake assembly of claim 7, wherein the plurality of concentric springs consists of two concentric springs.

9. The vehicle brake assembly of claim 6, further comprising:
at least one spring separator disposed between adjacent concentric springs.

10. The vehicle brake assembly of claim 9, wherein first and second spring-seat end flanges are formed at opposite ends of at least one separator, the first flange receiving an end face of a first one of the concentric springs, and the second flange receiving an end face of a second one of the concentric springs, such that spring force is transferred in series from the first one of the springs through the separator to the second one of the springs.

11. A vehicle axle assembly, comprising:
a vehicle axle;
a brake coupled to the vehicle axle, wherein the brake includes one of a disc brake caliper and a drum brake; and
a spring brake actuator coupled to the brake to apply a brake actuation force, the spring brake actuator having a housing containing
a parking brake release actuator;
a service brake actuator;
a brake actuator spring disposed between the brake actuators; and
a spring retainer disposed between the brake actuator spring and the service brake actuator and coupled to the parking brake release actuator;
wherein the brake actuator spring comprises a plurality of concentric springs.

12. The vehicle axle assembly of claim 11, wherein the springs are concentric with an axis passing through centers of the spring retainer and the parking brake release actuator.

13. The vehicle axle assembly of claim 12, wherein the plurality of concentric springs consists of two concentric springs.

14. The vehicle axle assembly of claim 11, further comprising:
at least one spring separator disposed between adjacent concentric springs.

15. The vehicle axle assembly of claim 14, wherein first and second spring-seat end flanges are formed at opposite ends of at least one separator, the first flange receiving an end face of a first one of the concentric springs, and the second flange receiving an end face of a second one of the concentric springs, such that spring force is transferred in series from the first one of the springs through the separator to the second one of the springs.

16. A vehicle, the vehicle being self-propelled vehicle or a non-self-propelled trailer, comprising:
a vehicle body;
a vehicle axle coupled to the vehicle body;
a brake coupled to the vehicle axle, wherein the brake includes one of a disc brake and a drum brake; and
a spring brake actuator coupled to the brake to apply a brake actuation force, the spring brake actuator having a housing containing
a parking brake release actuator;
a service brake actuator;
a brake actuator spring disposed between the brake actuators; and
a spring retainer disposed between the brake actuator spring and the service brake actuator and coupled to the parking brake release actuator;
wherein the brake actuator spring comprises a plurality of concentric springs.

17. The vehicle of claim 16, wherein the springs are concentric with an axis passing through centers of the spring retainer and the parking brake release actuator.

18. The vehicle of claim 17, wherein the plurality of concentric springs consists of two concentric springs.

19. The vehicle of claim 16, further comprising:
at least one spring separator disposed between adjacent concentric springs.

20. The vehicle of claim 19, wherein first and second spring-seat end flanges are formed at opposite ends of at least one separator, the first flange receiving an end face of a first one of the concentric springs, and the second flange receiving an end face of a second one of the concentric springs, such that spring force is transferred in series from the first one of the springs through the separator to the second one of the springs.

21. A method of assembling power springs within a spring brake actuator housing, comprising the acts of:
disposing at least one spring separator between at least two concentric springs, such that a first portion of the spring separator is in contact with an inner one of the at least two concentric springs, and a second portion of the spring separator is in contact with an outer one of the at least two concentric springs;
inserting the at least two concentric springs into an intermediate housing portion of the spring brake actuator housing,
compressing the at least two concentric springs; and
retaining the at least two concentric springs in the intermediate housing portion between a service brake actuator located on one side of the intermediate housing portion and a parking brake release actuator located an opposing side of the intermediate housing portion.

22. The method of assembling power springs within a spring brake actuator housing of claim 21, wherein the at least two concentric springs are not in contact with each other.

23. The method of assembling power springs within a spring brake actuator housing of claim 21, wherein the spring separator is cup-shaped.

24. A method of assembling a pneumatic spring brake actuator, comprising the steps of:
providing a spring brake actuator housing having a power spring chamber, a service brake actuator chamber and a parking brake actuator chamber, wherein said chambers have a common longitudinal axis;
disposing at least one spring separator between at least two concentric springs, such that a first portion of the spring separator is in contact with an inner one of the springs, and a second portion of the spring separator is in contact with an outer one of the at least two concentric springs;
disposing an intermediate tube on the longitudinal axis, wherein the power spring chamber and parking brake actuator chamber are adjacent to one another, the intermediate tube extends through at least a portion of the parking brake actuator chamber and the power spring chamber, and a parking brake actuator diaphragm is located on a parking brake actuator end of the intermediate tube;
disposing the at least two concentric springs and separator in the power spring chamber concentrically about the intermediate tube;
affixing a spring plate to a power spring chamber end of the intermediate tube; and
compressing the at least two concentric springs into the power spring chamber.

25. The method of assembling a pneumatic spring brake actuator of claim 24, wherein a first one of the at least two concentric springs is an inner spring and a second one of the two concentric springs is an outer spring.
